(19) United States
(12) Patent Application Publication
(10) Pub. No.: US 2014/0318469 A1
(43) Pub. Date: Oct. 30, 2014

(54) INDOOR KENNEL

(71) Applicants: Kevin Wade Beasley, Grovetown, GA (US); Ashley Joan Ortiz, Grovetown, GA (US)

(72) Inventors: Kevin Wade Beasley, Grovetown, GA (US); Ashley Joan Ortiz, Grovetown, GA (US)

(21) Appl. No.: 13/871,342

(22) Filed: Apr. 26, 2013

(51) Int. Cl. A01K 1/02

(52) U.S. Cl. CPC A01K 1/0245
USPC 119/497

(57) ABSTRACT

A kennel for pet containment comprising: a rectangular cuboid enclosure; a top handle positioned on a top surface of the cuboid enclosure; a series of vented openings along each side panel of the cuboid enclosure; a removable drawer positioned below a inside floor of the cuboid enclosure; a series of vented opening along a back side of the cuboid enclosure; and a grated front door. The door latch may be placed on an outer surface of the grated front door and a drawer latch may extend across a front surface of the removable drawer.

### BACKGROUND OF THE INVENTION

1. Field of Invention

The present invention relates to an indoor kennel that includes a removable disposal drawer.

2. Description of Related Art

Many dog owners must leave their dogs in dog kennels when they leave their home for a period of time. The kennels provide a means to secure the dog in an enclosed environment to avoid any unintentional waste or accidents while the pet owner is away from the residence. Many times if pets are left outside of a kennel and allowed to roam throughout a residence they may occasionally urinate or release a bowel movement within the residence. Further a pet that is allowed to roam without supervision may destroy certain items in the home due to boredom such as chewing books or tipping over small tables or lamps or other pet-related incidents.

Consequently, the pet owner must secure the dog to avoid these incidents while they are away from the residence. However many pet owners do not appreciate or enjoy placing their pets in an enclosed kennel. Many times when placed in an enclosed kennel there is not enough room or space for the pet to release any waste. It would therefore be advantageous to have an enclosed kennel so as a pet owner may enclose their pet but however have a means to effectively and efficiently dispose of waste in the kennel and to have the waste contained away from the pet while in the kennel.

### SUMMARY OF THE INVENTION

The present invention relates to a kennel for pet containment comprising: a rectangular cuboid enclosure; a top handle positioned on a top surface of the cuboid enclosure; a series of vented openings along each side panel of the cuboid enclosure; a removable drawer positioned below a inside floor of the cuboid enclosure; a series of vented opening along a back side of the cuboid enclosure; and a grated front door. The door latch may be placed on an outer surface of the grated front door and a drawer latch may extend across a front surface of the removable drawer.

### BRIEF DESCRIPTION OF DRAWINGS

FIG. 1 depicts a side view of the kennel in accordance with the present invention.

FIG. 2 depicts a rear view of the kennel in accordance with the present invention.

FIG. 3 depicts a front view of the kennel in accordance with the present invention.

FIG. 4 depicts embodiments of a waste drawer that is associated with the present invention.

### DETAILED DESCRIPTION

The present invention relates to an indoor kennel that provides a means for a pet owner to enclose and cage their pet when necessary. The kennel in accordance with the present invention includes a grated door and vented openings on the side and back panels of the kennel. The door releases and allows for the entry of a pet. Various attachment means can be implemented to secure the door once the pet is inside the kennel. The bottom surface of the kennel is also grated. The grated bottom allows for the release of waste into a drawer that is under the bottom surface of the kennel. The drawer under the bottom surface of the kennel may be removed with a drawer latch attached to the front side of the drawer. The drawer latch allows the kennel owner to slide the drawer out of the kennel and dispose of the waste within the drawer that may be produced while the pet is within the kennel.

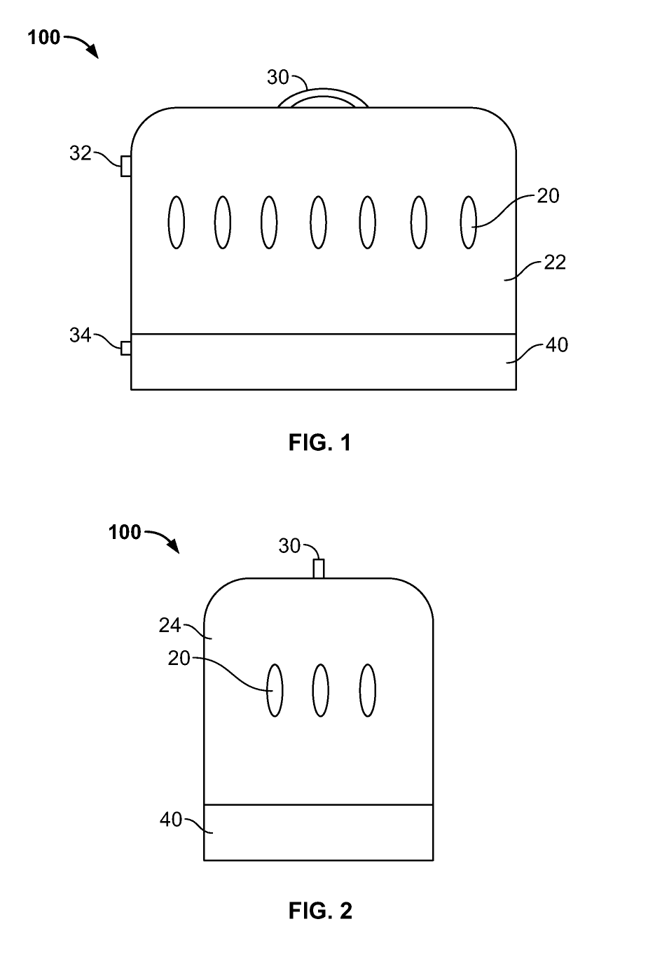

In reference to FIG. 1, a side view of an Indoor Kennel 100 is depicted. The Indoor Kennel 100 includes a Top Handle 30 and a series of Vented Openings 20 along a Side Panel 22 of the Kennel 100. The side view of the Kennel 100 is replicated on the opposite side of the kennel creating a rectangular cuboid. Below the Kennel 100 is a Drawer 40 as shown that includes a Drawer Latch 34. Also depicted on the side view is a Door Latch 32 that allows for the opening and closing of the front door and entrance into the Kennel 100. This feature allows for the homeowner or pet owner to easily maneuver the kennel to different locations in their home with the use of the Handle 30. Further the Vented Openings 20 again allow for a sufficient air flow through the Kennel 100 while the pet is within the Kennel 100.

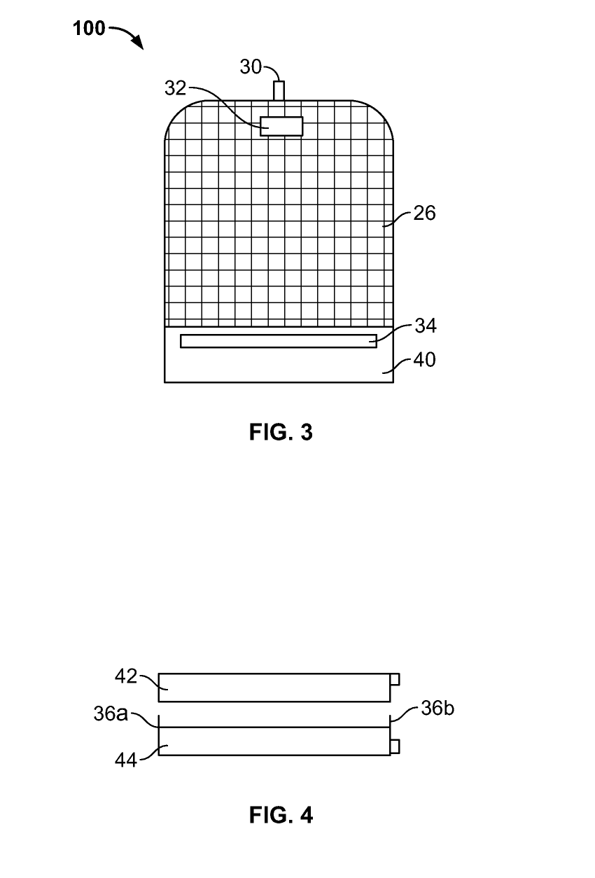

FIG. 2 depicts a rear view of the Kennel 100. The rear view also includes the series of Vent Openings 20 along a Back Side 24. Also shown on the rear side is the Drawer 40 and Handle 30 that extends upwardly from the top surface of the Kennel 100. With respect to FIG. 3, a front view of the Kennel 100 is depicted. This front view shows a Grated Door 26 with the Door Latch 32. The Door Latch 32 enables the user to open and close the Grated Door 26. Also seen more clearly is the Drawer Latch 34. The Drawer Latch 34 extends across the horizontal surface of the Drawer 40.

During use the pet is placed within the enclosed kennel and a grated bottom, not shown, within the kennel allows for the dropping of waste into the Drawer 40. The pet owner may easily remove the Drawer 40 by pulling the Latch 34 and then disposing of the waste as needed. The removable Drawer 40 allows for easy cleaning of the kennel and spacing of the waste away from the pet while within the kennel. The drawer may be reusable and therefore after cleaning may be inserted back into the kennel for further use.

FIG. 4 depicts two embodiments of exemplary drawers for use with the present invention. Drawer 42 is a litter drawer that includes a latch for use with the present invention. Another alternative drawer is shown with Drawer 44. The Drawer 44 includes Pad Hooks 36a, 36b that allow for the attachment of a pad that extends across the surface of the Drawer 44. The pad provides a further means for easy cleaning of the drawer when waste is deposited within the drawer by a pet within the kennel.

Consequently the kennel with respect to the present invention provides a convenient means to clean the kennel and also a means for the depositing of waste by the pet while within the kennel. The use of the grating at the bottom of the kennel allows for the waste to drop through the grating and into the drawer that is easily removed for cleaning. The instant invention has been shown and described in what it considers to be the most practical and preferred embodiments. It is recognized, however, that departures may be made there from within the scope of the invention and that obvious modifications will occur to a person skilled in the art.

What is claimed is:

1. A kennel for pet containment comprising:
a. a rectangular cuboid enclosure;
b. a top handle positioned on a top surface of the cuboid enclosure;
c. a series of vented openings along each side panel of the cuboid enclosure;
d. a removable drawer positioned below a inside floor of the cuboid enclosure;
e. a series of vented opening along a back side of the cuboid enclosure; and
f. a grated front door.

2. The kennel according to claim 1, further including a door latch placed on an outer surface of the grated front door.

3. The kennel according to claim 1, where a drawer latch extends across a front surface of the removable drawer.

4. The kennel according to claim 1, where the removable drawer includes pad hooks extending vertically from the removable drawer.
